(19) United States
(12) Patent Application Publication
(10) Pub. No.: US 2013/0033035 A1
(43) Pub. Date: Feb. 7, 2013

(54) Pipe Connector Device

(71) Applicants: John Gallagher, Aberdeen (GB); David J.E. Morgan, Aberdeen (GB)

(72) Inventors: John Gallagher, Aberdeen (GB); David J.E. Morgan, Aberdeen (GB)

(73) Assignee: OIL STATES INDUSTRIES (UK) LIMITED, Aberdeen, Aberdeenshire (GB)

(21) Appl. No.: 13/640,599

(22) PCT Filed: Mar. 24, 2011
(86) PCT No.: PCT/GB2011/050600

§ 371 Date: Oct. 30, 2012

(30) Foreign Application Priority Data
Apr. 15, 2010 (GB) 1006336.0

(51) Int. Cl. E21B 17/04; F16L 21/00; E21B 17/042; F16L 15/04

(52) U.S. Cl. 285/332.2

(57) ABSTRACT

A pipe connector comprises a tubular pin member 1 having a generally frustoconical outer peripheral surface 3 and a tubular box member 2 having a generally frustoconical inner peripheral surface 4 corresponding to the frustoconical outer peripheral surface 3 of the pin member 1 and which overlies the frustoconical surface 4 of the pin member 1 when the members 1, 2 are fully engaged together. A circumferentially extending groove 14, 15 is formed in each of the pin member 1 and the box member 2 at the root end of the frustoconical surface 3, 4 thereof, and a nib 12, 13 is formed on the tip of each of the pin 1 and box 2 members such that, upon full engagement of the pin 1 and box 2 members, the nibs 12, 13 of the pin 1 and box 2 members engaging respectively in the grooves 14, 15 of the box 2 and pin 1 members so as to radially restrain the free ends of the pin 1 and box 2 members. Each nib 14, 15 is an interference fit with its mating groove so as to form a seal therewith, wherein at least one of the inner diametrical surface 14a of the groove 14 in the box member 2 and the outer diametrical surface 15a of the groove 15 in the pin member 1 is inclined relative to the abutting surface 12a; 13a of the nib member 12, 13 engageable therein, such that said abutting groove and nib surfaces 12a, 14a; 13a, 15a diverge from each other towards the bottom of the groove 14; 15.

The present invention relates to improvements in pipe connectors particularly but not exclusively for use in the oil industry for connecting metal pipe sections of pipe strings.

So called Merlin type pipe connectors are well known in the art for connecting pipes together and are disclosed in GB1573945, GB2033518, GB2099529, GB2113335 and GB2138089. The connection is formed by a tubular pin member having a frustoconical outer peripheral surface and a tubular box member having a generally frustoconical inner peripheral surface corresponding to the frustoconical outer peripheral surface of the pin member. In use, the two members, each associated with a pipe section, are telescoped together and are axially locked together by mating annular projections and grooves provided on the said peripheral surfaces, the projections and grooves being spaced apart along the two surfaces.

In telescoping the two members together, they are initially telescoped until surface contact is made between crest surfaces of the projections and surfaces between the grooves at least at the ends of the overlapped portions of the surfaces. The leading edges of the crest and groove surfaces, that is the edges which engage against each other when the pin and box members are pushing together, are ramped so as facilitate the passing of the surfaces over each other during engagement. Hydraulic fluid under pressure is typically supplied between the overlapped parts of the surfaces to expand the box member and/or contract the pin member to permit the members to be fully telescoped together. Alternatively, the members may simply be pushed together with sufficient force to enable overlapping surfaces to ride over each other until full engagement is achieved. Pressurised hydraulic fluid is also used to disengage the members by expanding the box member and/or contracting the pin member to bring the projections out of engagement with the corresponding grooves.

In order to seal the ends of the pin and box members, and also to restrain them against unintentional radially outward and inward deflection when the members are fully engaged, an inner seal is formed between the free end of the pin member and the root end of the box member, and an outer seal is formed between the free end of the box member and the root end of the pin member. Each seal is formed by an axially extending nib or projection which is formed on the free end of the conical surface of each of the box and pin members. A complementary shaped annular groove in then formed adjacent the root end of the conical surface of each of the pin and box members, the groove being formed narrower than the corresponding nib. When the pin member is fully pressed into the box member, the nib on its free end engages in the groove formed at the root of the box member, thereby restraining the free end of the pin member from radial movement relative to the box member. The size difference between the nib and the groove effects and interference fit therebetween, both the nib and groove deforming during the engageable process. In this way, and effective seal is formed at one end of the conical engaging surfaces.

Similarly, the nib on the free end of the box member engages in the groove at the root of the conical surface of the pin member, both nib and groove again deforming to effect and interference fit therebetween which effective seals the other end of the conical engagement surfaces.

Conventionally, the form of the nibs and grooves on the pin and box members are identical, so that the seal designs on the inside and outside diameters are identical. Indeed, the seals usually have perfect 180-degree rotational symmetry.

Existing systems have the problem, however, the deformation cycles resulting from repeated assembly and disassembly of the connector tends to cause damage to the nibs and groove, which can result in the effectiveness of the seals being lost. Also, the contact stresses arising between the nibs and grooves during engagement and disengagement of the connector in the prior art systems means that a typical conventional connector can only be reused a relatively small number of times before the resulting damage prevents the seals from forming.

According to a first aspect of the present invention, there is provided a pipe connector comprising a tubular pin member having a generally frustoconical outer peripheral surface and a tubular box member having a generally frustoconical inner peripheral surface corresponding to the frustoconical outer peripheral surface of the pin member and which overlies the frustoconical surface of the pin member when the members are fully engaged together, a circumferentially extending groove being formed in each of the pin member and the box member at the root end of the frustoconical surface thereof, and a nib being formed on the tip of each of the pin and box members such that upon full engagement of the pin and box members, the nibs of the pin and box members engaging respectively in the grooves of the box and pin members so as to radially restrain the free ends of the pin and box members, each nib being an interference fit with its mating groove so as to form a seal therewith, wherein at least one of the inner diametrical surface of the groove in the box member and the outer diametrical surface of the groove in the pin member is inclined relative to the abutting surface of the nib member engageable therein such that said abutting groove and nib surfaces diverge from each other towards the bottom of the grooves and wherein at least one of the nib and the groove of the tubular member is asymmetrical in shape such that, in use, the reaction point due to the engagement between the at least one nib and groove and the mating groove or nib of the mating tubular member on one side of the nib is longitudinally offset from the reaction point on the other side of the nib, whereby a counter clockwise moment is induced in the nib by the reaction forces.

A pipe connector in accordance with the first aspect of the invention has the advantage that it allows a greater surface contact area to be established at the relevant locations as the ligaments of material at the grooves deform on assembly, thus rotating the surface of each groove into alignment with the surface of the engaging nib. The greater contact area is, then, more tolerant of minor damage that can occur due to repeated assembly and disassembly of the connector. Furthermore, the flat surfaces formed by the deformation during engagement distribute the contact force across a larger area, thus reducing contact stress. Additionally the counter-clockwise moment induces compressive stress at the base of the nib which prevents significant cyclic tensile stress being generated during subsequent cycles of fatigue in the component arising from repeated connection to and release from the mating tubular member, or loads experienced during service, thereby improving the fatigue performance of the nib.

Preferably, both the inner diametrical surface of the groove in the box member and the outer diametrical surface of the groove in the pin member are inclined relative to the abutting surface of the associated nib members. This has the advantage of providing improved damage tolerance and reduced contact stress for both the inner and outer seals.

Advantageously, the angle of inclination is small, in particular substantially 1 degree.

It will be understood that in order to achieve the effect of a counter clockwise moment being induced in the nib by the reaction forces, it is required that the reaction points on the two sides of the nib be offset from each other. This may be achieved by provision of an asymmetrical groove interacting with a symmetrical or asymmetrical nib, or a symmetrical groove interacting with an asymmetrical nib. The groove may, for example, be formed with its side closest to the connector cone tapering, a symmetrical nib then being engageable therewith. However, this has the drawback that it would be difficult to inspect the correct formation of the groove during manufacture.

Accordingly, in a preferred embodiment, the longitudinal offset between the reaction points is achieved by the nib being of asymmetrical shape.

Furthermore, the nib is preferably shaped such that the reaction point at the side corresponding with the frustoconical peripheral surface is closer to the tip of the nib than the reaction point on the opposing side.

The present invention further provides a pipe connector comprising a pair of pipe connector components each in accordance with the second aspect of the invention and engageable with each other in order to effect a connection therebetween, a first of said components being a tubular pin member having its frustoconical surface on an outer peripheral surface, and a second of said components being a tubular box member having its frustoconical surface on an inner peripheral surface and each component having a circumferential groove formed at the base of its frustoconical surface in which is sealingly engageable the nib of the other component, one of the nib of the pin member and the groove of the box member being shaped such that the reaction point on the outer peripheral surface seal is closer to the end of the nib than the reaction point on the inner peripheral surface, and one of the nib of the box member and the groove of the pin member being shaped such that the reaction point on the inner peripheral surface of the seal is closer to the end of the nib than the reaction point on the outer peripheral surface.

Preferably, it is the nib of both the box and pin members which is asymmetrically shaped to achieve said offset between the reaction points.

Conventional Merlin type connectors have the inner end of their seal grooves formed with a semi-circular cross-sectional shape, that is with a constant radius. The deepest part of the seal groove (the root) of each of the pin and box members is subjected to two different types of load. First, when the connector is assembled and the seal surface is rotated slightly, a bending stress is set up at the root of the groove. Also, when significant tension loads are applied to the connector in service, the load path will tend to be crooked in the box component (if the connector is a typical ID flush riser type) or in the pin component (if the connector is an OD flush pile type), or else a mixture of both. The crooked route of the load path causes a rise in stress in the location of the seal groove. These tension loads are usually cyclic in nature and as such induce fatigue in the connector material.

According to a second aspect of the invention there is provided a pipe connector component comprising a tubular member having a generally frustoconical peripheral surface which, in use, overlaps and engages with a corresponding generally frustoconical surface of a mating tubular member in order to effect a connection therewith, the tubular member having a circumferentially extending sealing groove formed at the base of its frustoconical peripheral surface for receiving a nib formed on a tip of the corresponding frustoconical surface of the mating tubular member for effecting a sealing connection therewith, the root of the groove being shaped such that its cross-section includes at least one quadrant which is formed by a quarter ellipse whose major axis is one of aligned with and perpendicular to the centre line of the cross-section of the groove.

In one embodiment, the at least quadrant is formed by a quarter ellipse whose major axis is perpendicular to the centre line of the cross-section of the groove, said quadrant extending from said centre line to the side of the groove opposite the frustoconical surface. In the case of a pin member, this quadrant will, then, form the quadrant leading to the outer peripheral surface of the groove, and in the case of a box member, this quadrant will form the quadrant leading to the inner peripheral surface of the groove. This has the advantage that the bending stress, set up at the root of the groove when the sealing surface is rotated during connector assembly, is reduced.

The remainder of the cross-section of the groove may be formed by an arc of constant radius, the radius of which is equal to the major semi-axis of the quadrant formed by the quarter ellipse.

In another embodiment, the at least one quadrant is formed by a quarter ellipse whose major axis is aligned with the centre line of the cross-section of the groove, said quadrant extending from said centre line to the side of the groove aligned with the frustoconical surface. In the case of a pin member, this quadrant will, then, form the quadrant leading to the inner peripheral surface of the groove, and in the case of a box member, this quadrant will form the quadrant leading to the outer peripheral surface of the groove. This has the advantage that fatigue life of the material in the area of the groove is improved.

The remainder of the cross-section of the groove may be formed by an arc of constant radius, the radius of which is equal to the minor semi-axis of the quadrant formed by the quarter ellipse.

Preferably, however, the root of the groove is shaped such that its cross-section is formed by two quadrant, each of which is formed by a quarter ellipse, a first quadrant being formed by a quarter ellipse whose major axis is aligned with the centre line of the groove, said quadrant extending from said centre line to the side of the groove aligned with the frustoconical surface, and a second quadrant being formed by a quarter ellipse whose major axis is perpendicular to the centre line of the groove, said second quadrant extending from said centreline to the side of the groove opposite the frustoconical surface.

This has the advantage of both reducing stress and improving fatigue life.

Preferably, the major semi-axis of the second quadrant is equal to the minor semi-axis of the first quadrant.

In a particular preferred embodiment, a pipe connector is provided comprising a pair of pipe connector components each in accordance with the third aspect of the invention and engageable with each other in order to effect a connection therebetween, a first of said components being a tubular pin member having its frustoconical surface on an outer peripheral surface, and a second of said components being a tubular box member having its frustoconical surface on an inner peripheral surface. It will, of course, be understood that some or all the optional features of the third aspect of the invention may be used in conjunction with one but preferably both components of the pipe connector.

It is common in the art for a Merlin pipe connector of the type of the invention to have external abutment only, with a small abutment gap existing at the inside diameter. In this case, there is a small amount of room for the seal to flex during cycles of stress. The previously defined aspects of the invention help to overcome any adverse effects of such flexing, but there is still a need to further reduce the flexibility of the seals.

According to a third aspect of the invention there is provided a pipe connector comprising a tubular pin member having a generally frustoconical outer peripheral surface and a tubular box member having a generally frustoconical inner peripheral surface corresponding to the frustoconical outer peripheral surface of the pin member and which overlies the frustoconical surface of the pin member when the members are fully engaged together, a circumferentially extending groove being formed in each of the pin member and the box member at the root end of the frustoconical surface thereof, and a nib being formed on the tip of each of the pin and box members such that upon full engagement of the pin and box members, the nibs of the pin and box members engaging respectively in the grooves of the box and pin members so as to radially restrain the free ends of the pin and box members, each nib being an interference fit with its mating groove so as to form a seal therewith, wherein the inner seal, formed by the engagement of the nib of the box pipe member and the groove of the box member, is larger than the outer seal.

A connector in accordance with the fourth aspect of the invention has the advantage that the flexibility of the seal is greatly reduced.

Preferably, the nib of the pin member and the groove of the box member are wider in the radial direction than the nib and groove of the box and pin members respectively, in particular 10-20% wider. Instead or in additional, the nib may be longer and the groove correspondingly deeper.

It will be understood that while the various aspects of the invention have been described separately, the features of each aspect may be combined in any combination, optionally also including preferably features described in connection with each aspect of the invention.

In order that the invention may be well understood, there will now be described an embodiment thereof, given by way of example, reference being made to the accompanying drawings, in which:

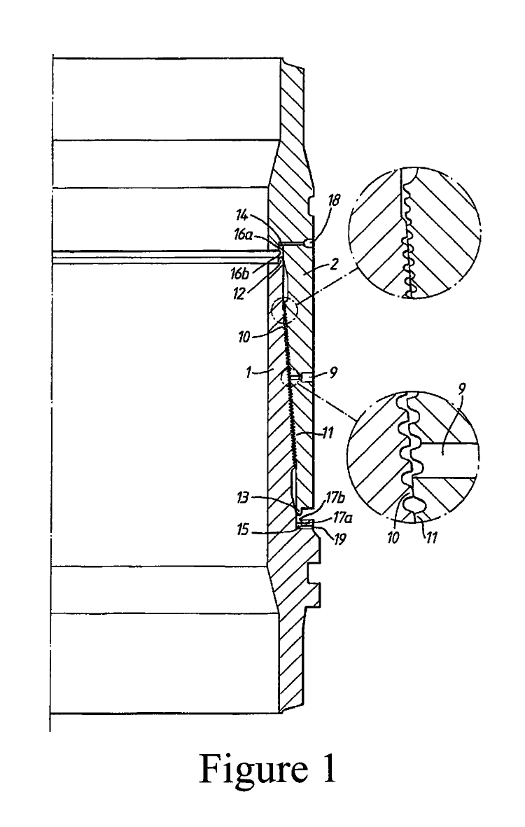

FIG. 1 is an axial section through a typical pipe connector showing the members in their initial telescoped together positions;

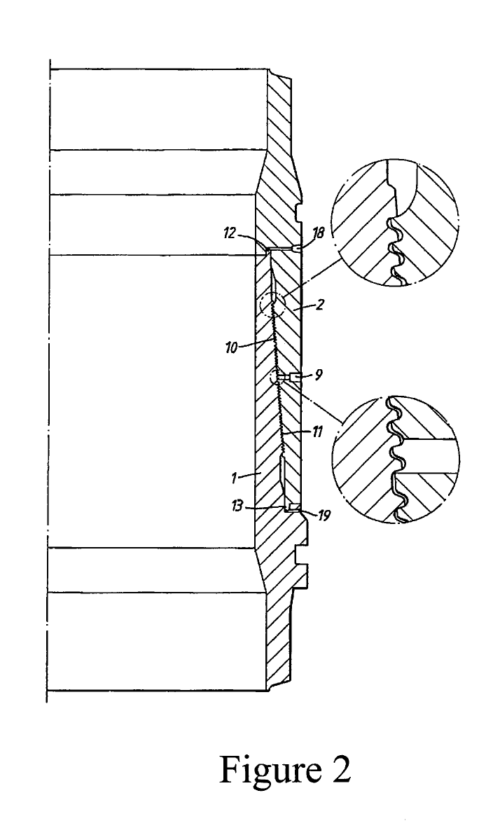

FIG. 2 is a section similar to that of FIG. 1 but showing the connector with the members fully engaged together;

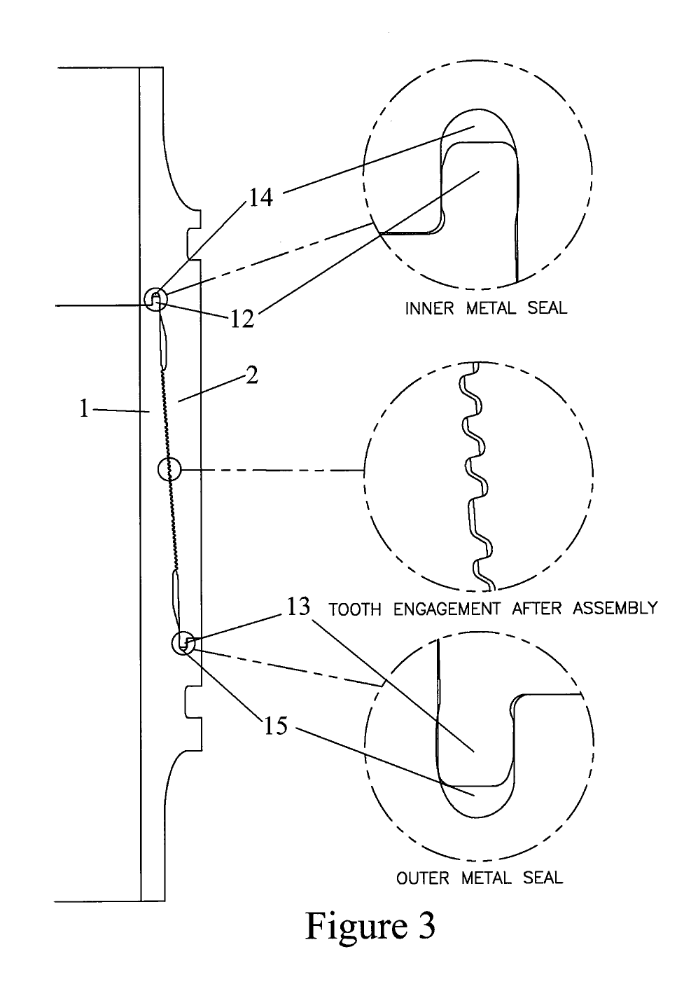

FIG. 3 is an enlarged view of the connector of FIG. 2 showing the inner and outer seals;

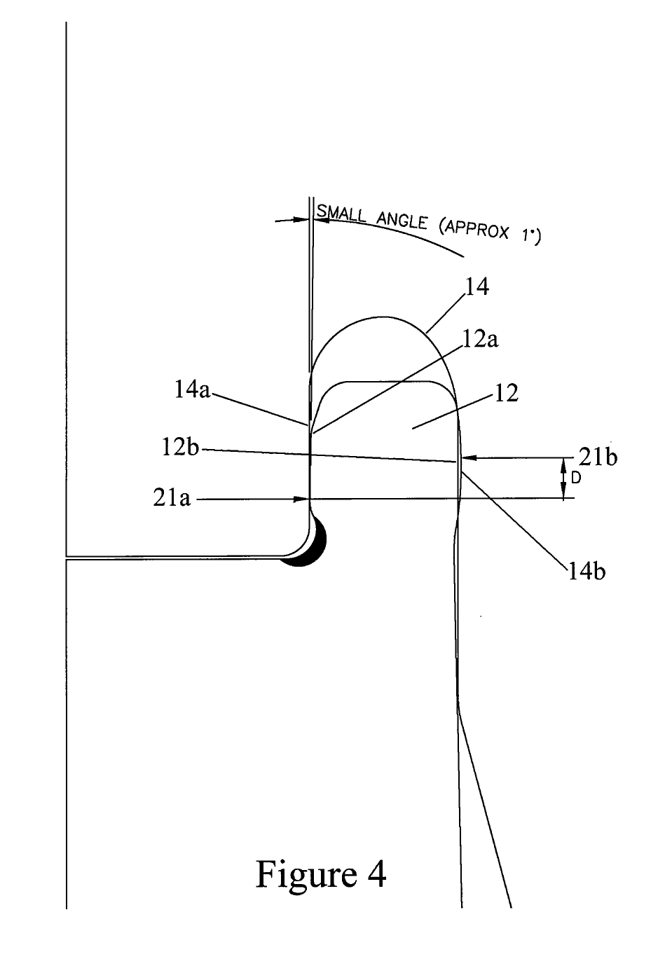

FIG. 4 is an enlarged view of the inner seal of FIG. 3 in its un-deformed state;

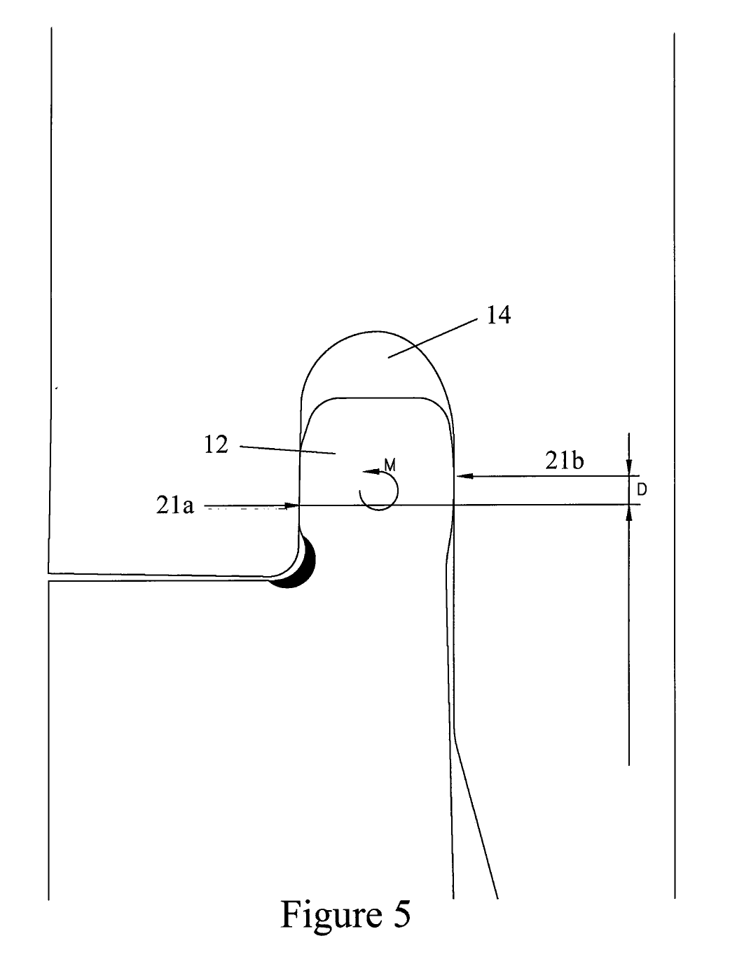

FIG. 5 is an enlarged view of the inner seal of FIG. 4 in a deformed state;

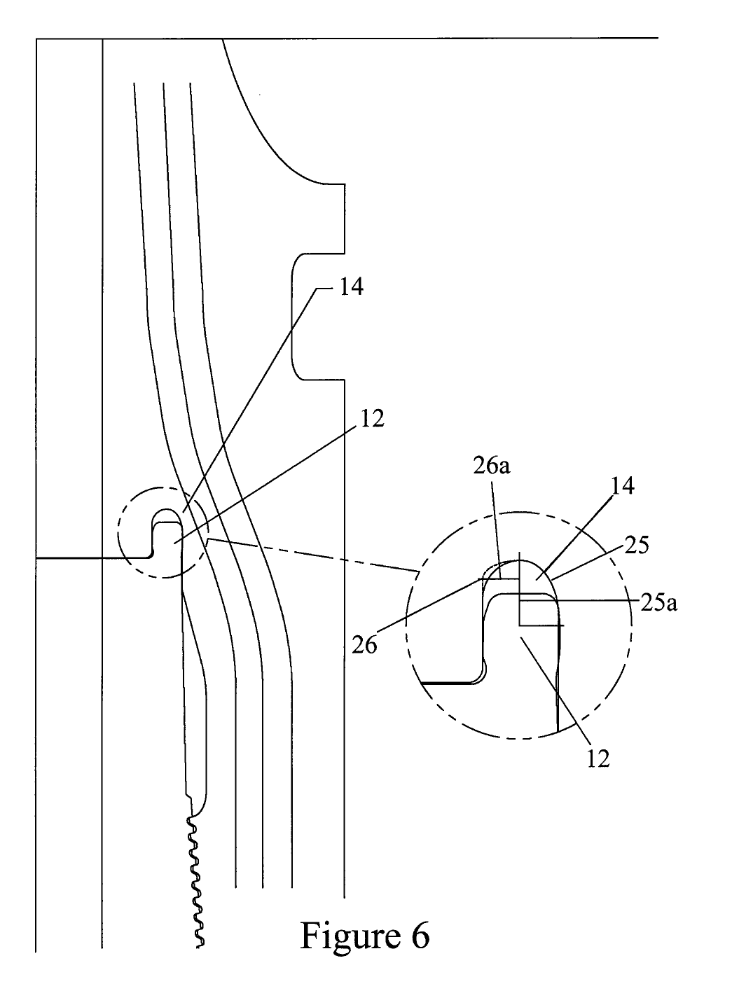

FIG. 6 is an enlarged view of the inner seal showing the shape of the quadrants forming the root of the inner seal groove; and

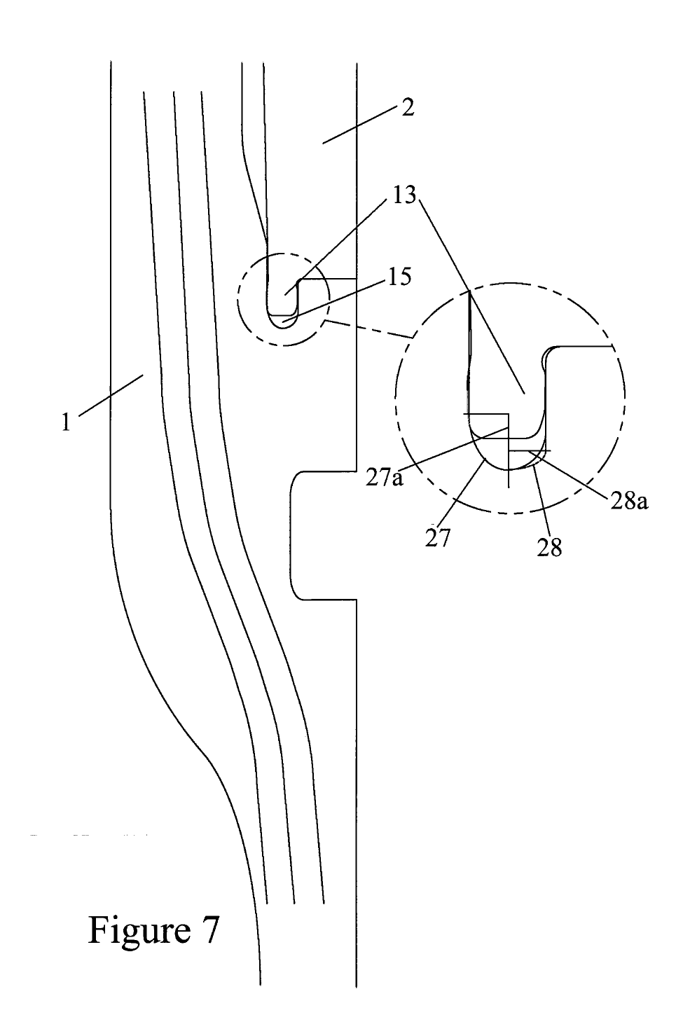

FIG. 7 is an enlarged view of the outer seal showing the shape of the quadrants forming the root of the outer seal groove

Referring first to FIGS. 1 and 2, there is shown a typical pipe connector known in the art, comprising a tubular pin member 1 and a tubular box member 2, which are connected, or to be connected e.g. by welding, to the ends of respective pipes. The members are designed to be telescoped together, the outer surface 3 of the pin member 1 and the inner surface 4 of the box member 2 being both generally frustoconical and provided with complementary annular projections 5 and grooves 6 which are axially spaced apart along the lengths of the surfaces intermediate the ends of the surfaces. The projections and grooves are relatively dimensioned so that, when the members are fully engaged together, corresponding ones of the projections inter-engage in the grooves to axially lock the members together. Pin member 1 is described herein as having projections 5 and box member 2 as having grooves 6, but it will be understood that these descriptions can be reversed.

Engagement of the members takes place in two stages. Initially, the members are brought together until contact is established between crest surfaces 7 of the projections 5 and surfaces 8 between the grooves 6. Thereafter, force is applied axially to complete engagement of the members. At the end of the first stage, a projection may yet have to pass over a plurality, for example three or four, grooves before it reaches its corresponding groove in which it is to engage. With this arrangement, to prevent inadvertent engagement of a projection with a groove which is not its corresponding groove, i.e. before the members are fully telescoped together, corresponding pairs of projections and grooves may be provided with differing axial extents and spacings along the length of the surfaces 3, 4. The projections 5 and grooves 6 are then arranged, for example as described in GB 2113335, so that at intermediate positions during telescoping of the members 3, 4, after the members have been brought into initial contact, at least some of the crest surfaces 7 of projections 5 spaced along the length of the surface 1 and intermediate the ends of the overlapped portions of the surfaces 3, 4, are aligned with surfaces 8 between the grooves, to prevent premature inter-engagement of the projections and grooves over any substantial length of the overlapped portions of the surfaces.

The arrangement and axial dimensioning of the spaced annular projections and grooves to prevent intermediate inter-engagement of the projections and grooves can be obtained in any number of different ways, for example as described in GB2113335.

After the members have been telescoped together to their initial positions, they may be fully engaged by simply applying an axial force to the members. Engagement may however be assisted, and the members may also be disengaged, by the application of pressurised hydraulic fluid between the overlapped portions of the surfaces. This pressurised fluid exerts radial loading on the overlapping surfaces, expanding the box and/or contracting the pin to create a clearance between the projections and the grooves so as to permit engagement and disengagement. The pressurised fluid also acts to lubricate the crest surfaces 7 of the projections 5 and surfaces 8 between the grooves 6 to facilitate sliding of these surfaces over one another.

As shown in FIGS. 1 and 2, the box member 2 is provided with a radial duct 9 for connection to a source of pressurised hydraulic fluid to enable pressurised fluid to be introduced between the overlapping members. The duct 9 opens inwardly of the box into the region of the frustoconical surface 4 of the box which is provided with the projections or grooves. In order to facilitate penetration of the pressurised fluid along the whole overlapping length of the members, axially extending grooves 10, 11 are provided, one in the pin member 1 and the other in the box member 2, which intersect the projections and grooves respectively, the duct 9 opening into the groove 11 in the box member.

To ensure sealing at the ends of the frustoconical surfaces 3, 4 of the members and to guard against any inadvertent escape of the pressurised hydraulic fluid from between the members during disengagement of the members, seals, shown in more detail in FIG. 3, are provided at or adjacent each end of the frustoconical surfaces 3, 4, the seals also radially restraining the free ends of the members. Each seal is formed by an annular axially extending nib or projection 12, 13 formed on the free end of each of the pin and box members 1, 2, and a corresponding groove 14, 15 formed at the inner end of the frustoconical surface of each of the box and pin members 2, 1. As the box member 2 reaches full engagement around the pin member 1, the nib 13 on the box member 2 engages in the groove 15 of the pin member 1 and vice-versa. The nib 12, 13 of each member 1, 2 seals laterally against surface portions 16a and 16b, 17a and 17b of the groove 14, 15 of the other member, surface portions 16a, 16b, 17a and 17b being provided with appropriate tapers for this purpose.

Each nib 12, 13 is wider than its mating groove 14, 15 so that an interference fit is formed between nib and groove upon engagement to ensure an effective seal is formed. To accommodate the formation of the interference fits, some deformation of both nib 12, 13 and groove 15, 14 occurs during engagement. In effect, each nib 12, 13 is in full interference fit in its corresponding groove 14, 15, when the members are fully engaged together. Surface portions 16a and 17a are extended along the surfaces of the members so that the nibs 12, 13 make sealing contact with these surfaces before the members are fully engaged and indeed, in their initial telescoped positions to provide seals at the ends of the overlapped portions of the frustoconical surfaces during assembly of the members. Ducts 18, 19 connecting the bottoms of the grooves 14, 15 with the exterior of the members are provided to allow hydraulic fluid to bleed away during assembly of the connector to ensure that the fluid does not become trapped between the members and thus prevent full engagement.

Referring next to FIG. 4, there is shown an enlargement of the pin nib seal, that is the seal formed between the nib 12 formed on the end of the pin member 1 and the groove 14 formed at the root of the box member 2. The nib 12 and groove 14 are configured so that there is an angular difference between the sealing surfaces 12a, 14a on the nib and groove respectively at the side of the seal closest to the inside diameter of the pin member 1, that is the two surfaces are inclined to each other such that the surfaces diverge from each other into the seal (towards the root end of the groove 14) as shown in FIG. 4.

The nib 13 of the box member 2 and groove 15 of the pin member 1 are similarly configured so that there is an angular difference between the sealing surfaces of the nib and groove formed at the root of the pin member 1, although in difference to the surfaces at the root of the box member 2, the angular difference is provided between the surfaces which are at the side of the seal closest to the outside diameter of the box member 2—effectively a 180 degree rotation from the arrangement at the root of the box member 2. The angular difference in each case is small, e.g. 1 degree, but has the advantage of allowing greater surface contact area to be established at the relevant locations as the ligament material at the seal groove deforms on assembly, thus rotating the surface of the seal groove into alignment with the surface of the seal nib as shown in FIG. 5.

As also illustrated in FIGS. 4 and 5, the nib 12 of the pin member 1 is formed with an asymmetrical shape between the inner sealing surface 12a and the outer sealing surface 12b. The shapes of these two surfaces are configured in relation to the engaging surfaces of the mating groove 14 of the box member 2 so that the effective point of engagement 21a of the inner sealing surface 12a of the nib 12 with the inner sealing surface 14a of the groove 14, which is the inner reaction point, is closer to the root end of the pin member 1 than the effective point of engagement 21b of the outer sealing surface 12b of the nib 12 with the outer sealing surface 14b of the groove 14, which is the outer reaction point. The separation is illustrated in FIG. 4 as the distance D. The result of this offset between the inner reaction point and the outer reaction point is that a counter-clockwise moment M is set up in the nib 12 as illustrated in FIG. 5. The counter-clockwise moment induces compressive stress in the filleted transition 22 at the base of the inner sealing surface of the nib 12, shown as shaded in FIGS. 4 and 5.

This compressive stress prevents significant cyclic tensile stresses being generated during subsequent cycles of fatigue in the connector, which results in an improved fatigue performance for the connector nib.

Again, a similar configuration is used for the nib 13 of the box member 1, but with the outer reaction point being closer to the root end of the box member 1 than the inner reaction point so as, again, to set up a counter-clockwise moment M in the nib 13 of the box member 1, which again induces compressive stress in the filleted transition at the base of the outer sealing surface of the nib 13.

Conventionally, the root of each seal groove is semi-circular in cross-section with a constant radius as shown, for example, in FIG. 3. A further feature of the present invention is the formation of the sealing grooves 14, 15 of the pin and box members 1, 2 with non-symmetrical cross-sections.

As illustrated in FIG. 6, the seal groove 14 of the box member 2, which forms part of the inner seal, has a cross section which is divided into two halves 25, 26, each of which is formed by a quarter ellipse. The first section 25 forms the quadrant closest to the outside of the connector assembly and defines a shape of a quarter ellipse who major axis 25a is aligned with the central axis of the groove 14, that is the axis which is parallel to the longitudinal axis of the connector and extends centrally between the inner and outer sealing surfaces of the groove 14. The second section 26 forms the inner quadrant of the root of the groove 14. The major axis 26a of the quarter ellipse formed by the second section 26 is oriented at 90 degrees to the central axis of the groove 14, and the first and second sections 25, 26 intersect at the bottom of the groove on the central axis. As can clearly be seen in FIG. 6, the major semi-axis of the second section 26 is equal to the minor semi-axis of the first section 25, and each section is a 90-degree quadrant of an ellipse extending from a minor semi-axis to a major semi-axis.

The seal groove 15 of the pin member 1, shown in FIG. 7, which forms part of the outer seal, similarly has a cross-sectional shape at the bottom by two elliptical quadrants 27, 28. In the case of this outer seal groove 15, however, the first section 27, whose major axis 27a is aligned with the longitudinal axis of the groove 15, forms the inner quadrant of the groove, and the second section 28, whose major axis 28a is perpendicular to the longitudinal axis of the groove 15, forms the outer quadrant of the groove 15. As with the groove 14 of the box member 2, the major semi-axis of the second section 28 of the outer seal groove 15 is equal to the minor semi-axis of the first section 27, and each section is a 90 degree quadrant of an ellipse extending from a minor semi-axis to a major semi-axis.

As still further feature of the connector assembly of the invention is the formation of the inner seal, that is the nib 12 of the pin member 1 and the groove 14 of the box member 2, to be larger than the outer seal, the interference fit between each nib and its associated groove being maintained. Preferably the inner seal is 10-20% larger than the outer seal. In this way, the flexibility of the seal during cycles of stress is reduced as compared to the prior art approach of having 180-degree rotational symmetry between the inner and outer seals. The enlargement may be achieved by increasing the radial thickness of the nib and groove, but increasing the length/depth, or both.

1-25. (canceled)

26. A pipe connector comprising a tubular pin member having a generally frustoconical outer peripheral surface and a tubular box member having a generally frustoconical inner peripheral surface corresponding to the frustoconical outer peripheral surface of the pin member and which overlies the frustoconical surface of the pin member when the members are fully engaged together, a circumferentially extending groove being formed in each of the pin member and the box member at the root end of the frustoconical surface thereof, each groove having an inner circumferential surface, an outer circumferential surface and an end surface extending between the inner and outer circumferential surfaces and a nib being formed on the tip of each of the pin and box members such that upon full engagement of the pin and box members, the nibs of the pin and box members engaging respectively in the grooves of the box and pin members so as to radially restrain the free ends of the pin and box members, each nib being an interference fit with its mating groove so as to form a seal therewith, wherein at least one of the inner circumferential surface of the groove in the box member and the outer circumferential surface of the groove in the pin member is inclined relative to the abutting surface of the nib member engageable therein such that said abutting groove and nib surfaces diverge from each other towards the bottom of the grooves and wherein at least one of the nib and the groove of the tubular member is asymmetrical in shape such that, in use, the reaction point due to the engagement between the at least one nib and groove of the one tubular member and the mating groove or nib of the other tubular member on one side of the nib is longitudinally offset from the reaction point on the other circumferential side of the nib, whereby a counter clockwise moment is induced in the nib by the reaction forces.

27. A pipe connector according to claim 26, wherein both the inner circumferential surface of the groove in the box member and the outer circumferential surface of the groove in the pin member are inclined relative to the abutting surface of the associated nib members.

28. A pipe connector according to claim 26, wherein the angle of inclination is substantially 1 degree.

29. A pipe connector component according to claim 26, wherein at least the groove of the tubular member is asymmetrical.

30. A pipe connector according to claim 26, wherein the nib of the tubular member is asymmetrically shaped.

31. A pipe connector according to claim 30, wherein the groove of the tubular member is symmetrical

32. A pipe connector according to claim 30, wherein the nib is shaped such that the reaction point at the side corresponding with the frustoconical peripheral surface, is closer to the tip of the nib than the reaction point on the opposing side.

33. A pipe connector comprising a pair of pipe connector components each in accordance with claim 26, and engageable with each other in order to effect a connection therebetween, a first of said components being a tubular pin member having its frustoconical surface on an outer peripheral surface, and a second of said components being a tubular box member having its frustoconical surface on an inner peripheral surface, each component having a circumferential groove formed at the base of its frustoconical surface in which is sealingly engageable the nib of the other component, one of the nib of the pin member and the groove of the box member being shaped such that the reaction point on the outer peripheral surface seal is closer to the end of the nib than the reaction point on the inner peripheral surface, and one of the nib of the box member and the groove of the pin member being shaped such that the reaction point on the inner peripheral surface of the seal is closer to the end of the nib than the reaction point on the outer peripheral surface.

34. A pipe connector according to claim 33, wherein the nib of the box member and the nib of the pin member are both asymmetrically shaped so as to achieve said offset between the reaction points.

35. A pipe connector component comprising a tubular member having a generally frustoconical peripheral surface which, in use, overlaps and engages with a corresponding generally frustoconical surface of a mating tubular member in order to effect a connection therewith, the tubular member having a circumferentially extending sealing groove formed at the base of its frustoconical peripheral surface for receiving a nib formed on a tip of the corresponding frustoconical surface of the mating tubular member for effecting a sealing connection therewith, a cross-section through the groove at any point around the tubular module having an axially extended centre line, the root of the groove has a cross-section which includes at least one quadrant which is formed by a quarter ellipse whose major axis is one of aligned with and perpendicular to the centre line of the cross-section of the groove.

36. A pipe connector component according to claim 35, wherein the at least one quadrant is formed by a quarter ellipse whose major axis is perpendicular to the centre line of the cross-section of the groove, said quadrant extending from said centre line to the side of the groove opposite the frustoconical surface.

37. A pipe connector component according to claim 35, wherein the component is a pin member and the at least one quadrant forms the quadrant leading to the outer peripheral surface of the groove.

38. A pipe connector component according to claim 35, wherein the component is a box member and the at least one quadrant forms the quadrant leading to the inner peripheral surface of the groove.

39. A pipe connector component according to claim 35, wherein the remainder of the cross-section of the groove is formed by an arc of constant radius, the radius of which is equal to the major semi-axis of the quadrant formed by the quarter ellipse.

40. A pipe connector component according to claim 35, wherein the at least one quadrant is formed by a quarter ellipse whose major axis is aligned with the centre line of the cross-section of the groove, said quadrant extending from said centre line to the side of the groove aligned with the frustoconical surface.

41. A pipe connector component according to claim 40, wherein the component is a pin member, and the at least one quadrant forms the quadrant leading to the inner peripheral surface of the groove.

42. A pipe connector component according to claim 40, wherein the component is a box member, and the at least one quadrant forms the quadrant leading to the outer peripheral surface of the groove.

43. A pipe connector component according to claim 40, wherein the remainder of the cross-section of the groove is formed by an arc of constant radius, the radius of which is equal to the minor semi-axis of the quadrant formed by the quarter ellipse.

44. A pipe connector component according to claim 35, wherein the root of the groove is shaped such that its cross-section is formed by two quadrant, each of which is formed by a quarter ellipse, a first quadrant being formed by a quarter ellipse whose major axis is aligned with the centre line of the groove, said quadrant extending from said centre line to the side of the groove aligned with the frustoconical surface, and a second quadrant being formed by a quarter ellipse whose major axis is perpendicular to the centre line of the groove, said second quadrant extending from said centreline to the side of the groove opposite the frustoconical surface.

45. A pipe connector component according to claim 44, wherein the major semi-axis of the second quadrant is equal to the minor semi-axis of the first quadrant.

46. A pipe connector comprising a pair of pipe connector components each in accordance with claim 35, said pair of components being engageable with each other in order to effect a connection therebetween, a first of said components being a tubular pin member having its frustoconical surface on an outer peripheral surface, and a second of said components being a tubular box member having its frustoconical surface on an inner peripheral surface.

47. A pipe connector comprising a tubular pin member having a generally frustoconical outer peripheral surface and a tubular box member having a generally frustoconical inner peripheral surface corresponding to the frustoconical outer peripheral surface of the pin member and which overlies the frustoconical surface of the pin member when the members are fully engaged together, a circumferentially extending groove being formed in each of the pin member and the box member at the root end of the frustoconical surface thereof, and a nib being formed on the tip of each of the pin and box members such that, upon full engagement of the pin and box members, the nibs of the pin and box members engaging respectively in the grooves of the box and pin members so as to radially restrain the free ends of the pin and box members, each nib being an interference fit with its mating groove so as to form a seal therewith, wherein the inner seal, formed by the engagement of the nib of the box pipe member and the groove of the box member, is at least one of wider in the radial direction and longer in the axial direction than the outer seal.

48. A pipe connector according to claim 47, wherein the nib of the pin member and the groove of the box member are wider in the radial direction than the nib and groove of the box and pin members respectively.

49. A pipe connector according to claim 48, wherein the nib of the pin member and the groove of the box member are 10-20% wider in the radial direction than the nib and groove of the box and pin members respectively.

50. A pipe connector according to claim 47, wherein the nib of the pin member is longer than the pin of the box member, and the groove of the box member in which the nib of the pin member engages is correspondingly deeper than the groove of the pin member.
